(19) United States
(12) Patent Application Publication
(10) Pub. No.: US 2025/0353156 A1
(43) Pub. Date: Nov. 20, 2025

(54) DIE RETENTION SYSTEMS AND METHODS FOR A HYDRAULIC TOOL

(71) Applicant: Milwaukee Electric Tool Corporation, Brookfield, WI (US)

(72) Inventors: Robert L. Markus, Mukwonago, WI (US); Michael W. Auskings, Hartland, WI (US); Ming Cong Chen, Hua Zhou (CN); Mathew R. Rentmeester, Wauwatosa, WI (US); Spencer J. Tiegs, Pewaukee, WI (US)

(21) Appl. No.: 19/209,047

(22) Filed: May 15, 2025

Related U.S. Application Data
(60) Provisional application No. 63/647,913, filed on May 15, 2024.
(60) Provisional application No. 63/696,695, filed on Sep. 19, 2024.
(60) Provisional application No. 63/773,828, filed on Mar. 18, 2025.

(51) Int. Cl. B25F 3/00

(52) U.S. Cl. CPC B25F 3/00

(57) ABSTRACT

A die retention mechanism for a hydraulic power tool includes a first die and a ram. The first die includes a flange and a first series of keyed protrusions extending from the flange. The ram includes a first end defining a slot to receive the flange of the first die. The slot is defined by a first ledge and a second ledge, with the first ledge including a second series of keyed protrusions. The second series of keyed protrusions interlocks with the first series of keyed protrusions to secure the first die to the ram.

### CROSS-REFERENCE TO RELATED APPLICATIONS

This application claims the benefit of U.S. Provisional Application No. 63/647,913, filed May 15, 2024, U.S. Provisional Application No. 63/696,695, filed Sep. 19, 2024, and U.S. Provisional Application No. 63/773,828, filed Mar. 18, 2025, each of which are hereby incorporated by reference in their entirety.

### BACKGROUND

Hydraulic tools (e.g., hydraulic crimper/cutter tools) typically include a head including one or more jaws, which may include a crimping or cutting die, depending on the intended use case of the tool. Typically, crimper/cutter tools include a ram that exerts force on the one or more jaws, which may be used to perform a crimp or cut at a desired location. Put differently, hydraulic crimper/cutter tools may include a fixed jaw and a moveable jaw, with the moveable jaw selectively advanced towards the fixed jaw via actuation of the ram.

### SUMMARY

According to one aspect of the present disclosure, a die retention mechanism for a hydraulic power tool can include a first die and a ram. The first die can include a flange and a first series of keyed protrusions extending from the flange. The ram can include a first end defining a slot to receive the flange of the first die. The ram can also include a first ledge and a second ledge together defining the slot, with the first ledge including a second series of keyed protrusions. The second series of keyed protrusions can interlock with the first series of keyed protrusions to secure the first die to the ram.

In some examples, the first die and the ram can be retained within a head of the hydraulic power tool.

In some examples, the head of the hydraulic power tool can include a clevis defining a guide channel to guide movement of the first die during movement of the ram.

In some examples, the guide channel can include a first side defining a wall and a second side defining a shelf, with the wall and the shelf contacting opposing sides of the first die during movement of the first die.

In some examples, a height of the shelf can be less than a height of the wall.

In some examples, when the first die is secured to the ram, the shelf and the wall of the clevis can mitigate lateral movement of the first die.

In some examples, the first die can be one of a crimping die or a cutting die.

In some examples, the ram can further include a first portion defining a pocket at one end and a second portion defining a protrusion at one end, with the protrusion of the second portion nesting within the pocket of the first portion to rotatably secure the first portion to the second portion.

In some examples, the first portion can be rotatably secured to the second portion via a pin arranged through an aperture in the first portion and into a groove of the second portion.

In some examples, the first portion can be rotatably secured to the second portion via a retaining clip arranged between a first groove of the first portion and a second groove of the second portion.

According to another aspect of the present disclosure, a method of securing a die to a ram of a hydraulic power tool can include extending the ram of the hydraulic power tool into an extended position, with the ram arranged within a head of the hydraulic power tool, and the ram having a first end defining a slot with a first series of protrusions separated by a first series of grooves. The method can also include aligning a mounting flange of the die with the slot in the ram, with the mounting flange having a second series of protrusions separated by a second series of grooves. The method can further include sliding the second series of protrusions of the die through the first series of grooves of the ram in a first direction, and sliding the second series of protrusions of the die in a second direction, perpendicular to the first direction, until the second series of protrusions of the die align with the first series of protrusions of the ram.

In some examples, the method can further include sliding the second series of protrusions of the die in the second direction until a first side of the die contacts a wall formed in the head of the hydraulic power tool.

In some examples, the method can further include sliding the second series of protrusions of the die in the first direction until the mounting flange contacts a base of the slot in the ram.

In some examples, the ram can further include a first portion defining a pocket at one end and a second portion defining a protrusion at one end, with the protrusion of the second portion nesting within the pocket of the first portion to rotatably secure the first portion to the second portion.

In some examples, the first portion can be rotatably secured to the second portion via a pin arranged through an aperture in the first portion and into a groove of the second portion.

In some examples, the first portion can be rotatably secured to the second portion via a retaining clip arranged between a first groove of the first portion and a second groove of the second portion.

According to yet another aspect of the present disclosure, a hydraulic tool can include a body and a head extending from the body. The head can include a ram moveable between a retracted position and an extended position, and a die retention mechanism removably securing a die to the ram. The die retention mechanism can include a slot in a first end of the ram, with the slot having a first series of keyed protrusions, and a flange extending from the die, with the flange having a second series of keyed protrusions to interlock with the first series of keyed protrusions of the slot to secure the die to the ram.

In some examples, the first series of keyed protrusions of the slot and the second series of keyed protrusions of the flange can include interlocking chamfered edges.

In some examples, the first series of keyed protrusions and the second series of keyed protrusions can be interspaced by grooves.

In some examples, grooves of the first series of keyed protrusions can receive the second series of keyed protrusions during installation of the die.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a diagrammatic view of one example of a hydraulic tool according to aspects of the present disclosure.

FIG. 2 is a side view of a head of the hydraulic tool of FIG. 1.

FIG. 3 is a cross-sectional view of the head of FIG. 2 taken along line III-III of FIG. 2.

FIG. 4 is another cross-sectional view of the head of FIG. 2.

FIG. 5 is a yet another cross-sectional view of the head of FIG. 2.

FIG. 6 is an axonometric view of a ram of the head of FIG. 2.

FIG. 7 is an axonometric view of a die of the head of FIG. 2.

FIG. 8 is an axonometric view of a portion of the head of FIG. 2 with the die of FIG. 7 installed.

FIG. 9 is a side view of the head of FIG. 2 in an open configuration.

FIG. 10 is a side partial view of the portion of the head of FIG. 8 depicting a stage of a removal process of the die of FIG. 7.

FIG. 11 is a side partial view of the portion of the head of FIG. 8 depicting another stage of a removal process of the die of FIG. 7.

FIG. 12 is an axonometric partial view of another example of a head of the hydraulic tool of FIG. 1.

FIG. 13 is an axonometric partial view of the head of FIG. 12.

FIG. 14 is a cross-sectional view the head of FIG. 12 taken along line XIV-XIV of FIG. 13.

FIG. 15 is a cross-sectional partial view of another example of a head of the hydraulic tool of FIG. 1.

FIG. 16 is an axonometric partial view of another example of a head of the hydraulic tool of FIG. 1 including a retaining clip.

FIG. 17 is an axonometric partial view of the head of FIG. 16 with the retaining clip removed.

FIG. 18 is an axonometric partial view of the head of FIG. 16, with the retaining clip installed.

FIG. 19 is an axonometric partial view of another example of a head of the hydraulic tool of FIG. 1.

FIG. 20 is an axonometric partial view of another example of a head of the hydraulic tool of FIG. 1.

FIG. 21 is a cross-sectional view of the head of FIG. 20 taken along line XXI-XXI of FIG. 20.

FIG. 22 is an axonometric view of another example of a head of the hydraulic tool of FIG. 1 including a rotatable ram assembly.

FIG. 23A-C are axonometric views of the ram assembly of FIG. 22.

FIG. 24 is a cross-sectional view of another example of a rotatable ram assembly of the hydraulic tool of FIG. 1.

FIG. 25 is a detail view of the ram assembly of FIG. 24 showing the area within dashed box XXV of FIG. 24.

### DETAILED DESCRIPTION

The following discussion is presented to enable a person skilled in the art to make and use embodiments of the invention. Given the benefit of this disclosure, various modifications to the illustrated embodiments will be readily apparent to those skilled in the art, and the principles herein can be applied to other embodiments and applications without departing from embodiments of the invention. Thus, embodiments of the invention are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

In some examples, a hydraulic tool may include a head, which may include a clevis and a jaw rotatably secured to the clevis. The jaw may form a first or upper component of the head, which may be opened (e.g., via rotation) in order to insert, remove, or replace a die from the tool (e.g., a crimping die, a cutting die, etc.). In some example, the jaw may include a fixed die of the tool, which may work together with a moveable die of the tool (e.g., secured to a ram of the tool) to complete a crimp or cut on a workpiece.

In some examples, the clevis may form a main body of the head. Further, the clevis may include a pair of opposing sides, with a first side including a wall and a second side, opposite (e.g., laterally opposite) the first side, including a shelf. In some examples, the shelf of the clevis may define a height that is overall shorter than a height of the wall of the clevis. In some examples, the wall and the shelf of the clevis may serve as guides for installation and operation of a moveable die (e.g., a first die) of the tool.

In use, the moveable die may be actuated via extension or retraction of the ram of the tool. For example, the movable die may be moved towards the fixed die via extension of the ram and retracted away from the fixed die via retraction of the ram of the tool. In some examples, the moveable die may be directly secured to an end of the ram via a die retention mechanism, which may secure the die to the ram for movement with the ram.

In some examples, the die retention mechanism may include a series of spaced protrusions extending from a flange of the die and a series of corresponding spaced protrusions extending from the end of the ram. Put differently, both the moveable die and the ram may be keyed so that the die may selectively lock into the end of the ram. Further, to secure the die to the ram during use, the wall and shelf of the clevis may abut the sides (e.g., opposing sides) of the die so that lateral movement of the die is mitigated. Put differently, the wall and the shelf of the clevis may serve as guides for the die during actuation of the die (e.g., via the ram).

In one example, an installation process of the moveable die may include opening the head via rotation of the jaw to provide an operator access to the ram. Following this, the operator may advance the ram (e.g., extend the ram) so that the operator may slide the moveable die into engagement with the end of the ram. In some examples, if the operator does not extend the ram, the operator may be unable to insert the die into the ram due to contact between the die and the shelf of the clevis.

In one example, to slide the die into the ram, the operator may align the protrusions of the die with one or more corresponding slots of the ram (e.g., defined by the protrusions of the ram). The operator may then slide the die laterally so that the protrusions of the die are arranged below the protrusions of the ram (e.g., in a stacked arrangement), which interlocks the die and the ram. In one example, the operator may slide the die until a side of the die contacts the wall of the clevis, which may indicate alignment of the protrusions of the ram and die. In some cases, if the protrusions are not aligned the ram may be unable to retract as the die may contact the shelf of the clevis.

Once the protrusions are in alignment, the opposing sides of the die may be in contact with the shelf and the wall of the clevis, respectively (e.g., within respective guidance channels of the clevis). Thus, the wall and the shelf of the clevis may prevent lateral movement of the die during use, which prevents accidental removal of the die from the ram. Further, in some cases, during use (e.g., crimping or cutting a workpiece), the die may come out of contact with the shelf of the clevis (e.g., due to extension of the ram), however, as the jaw is closed during a cutting operation, the jaw (e.g., one or more respective guidance channels of the jaw) may serve as a guide to retain the die.

As should be appreciated, to remove the die from the ram, the operator may extend the ram (e.g., so the blade is past the shelf) and then open (e.g., via rotation) the jaw of the head. Following this, the operator may grip the die and slide the die laterally (e.g., towards the shelf of the clevis) to disengage the protrusions of the die from the protrusions of the ram. Once the protrusions are disengaged, the operator may slide the die vertically, so that the protrusions of the die slide thorough the slots of the ram and remove the die from the tool.

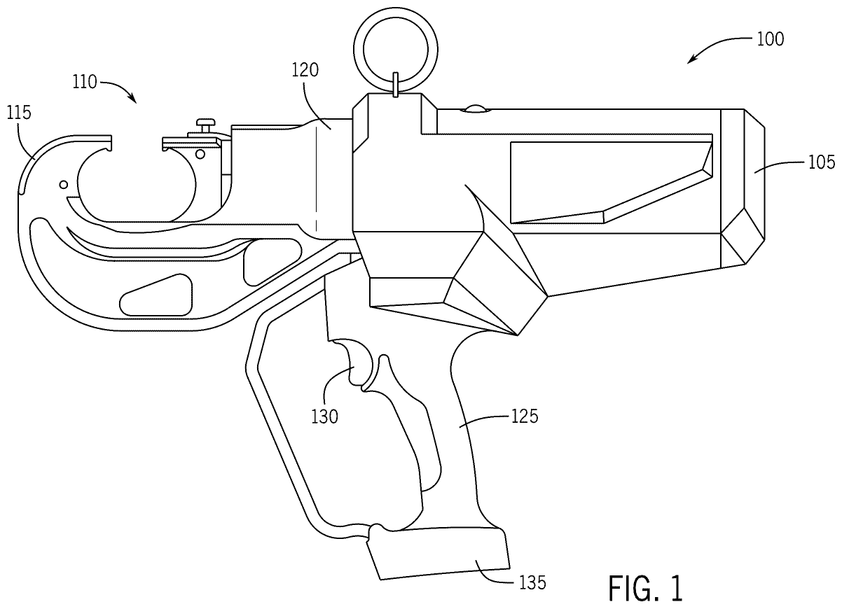

With reference to FIG. 1, a hydraulic tool 100 according to an example of the present disclosure is shown. In one example, the hydraulic tool 100 may be a crimping tool. However, in other examples, the hydraulic tool 100 may be a cutting tool. In yet other examples, the tool 100 may be interchangeable between a crimping tool and a cutting tool via interchangeability of a die (e.g., a crimping die or a cutting die) positioned within a head of the tool.

The hydraulic tool 100 may include a housing 105 that receives a crimper/cutter assembly 110 having a head 115 and a body 120. In one example, the body 120 of the assembly 110 may be positioned within the housing 105 of the tool while the head 115 of the assembly 110 is positioned outside of the housing 105. The housing 105 may further include a handle 125 to permit a user to grip and maneuver the tool 100. In some examples, the handle 125 may extend substantially perpendicular to the head 115. However, in other examples, the handle 125 may extend substantially parallel to the head 115 (e.g., in line with the head 115). In one example, the user may activate or deactivate operation of the tool 100 via actuation of a trigger 130 positioned on the handle 125. For example, a user may activate the tool 100 by depressing the trigger 130 and may deactivate the tool 100 by releasing the trigger 130. In one particular example, the tool 100 may include a battery receptacle 135 configured to receive and secure a battery (e.g., a rechargeable lithium ion battery, etc.) to power the tool 100. However, in other examples, the tool 100 may include a power cord to supply power to the tool 100. In one example, the head 115 generally defines a C-shape. However, in other examples, the head 115 may define other geometries, such as a U-shape.

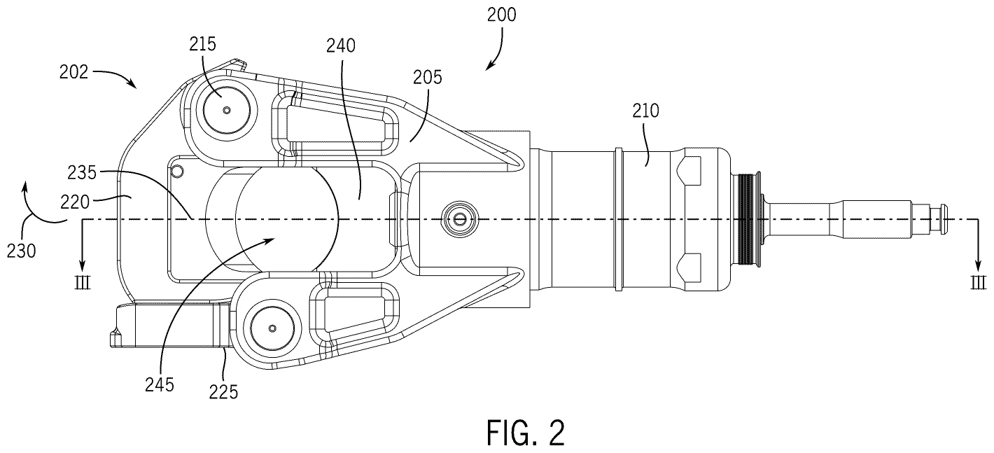

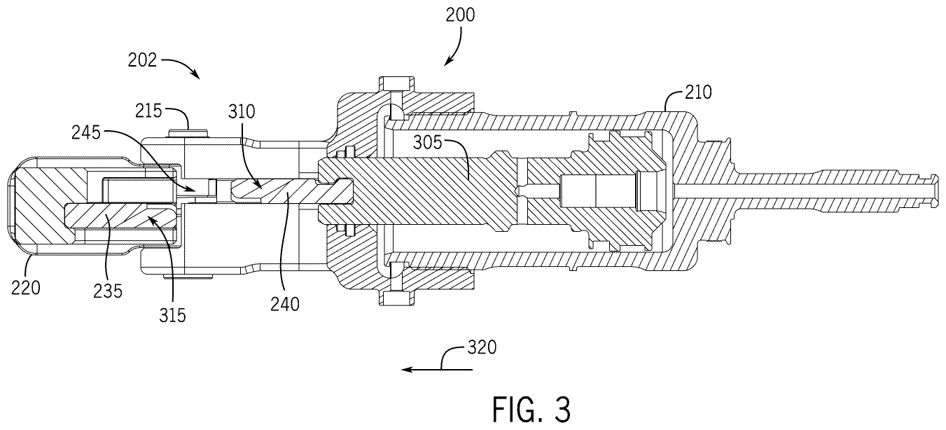

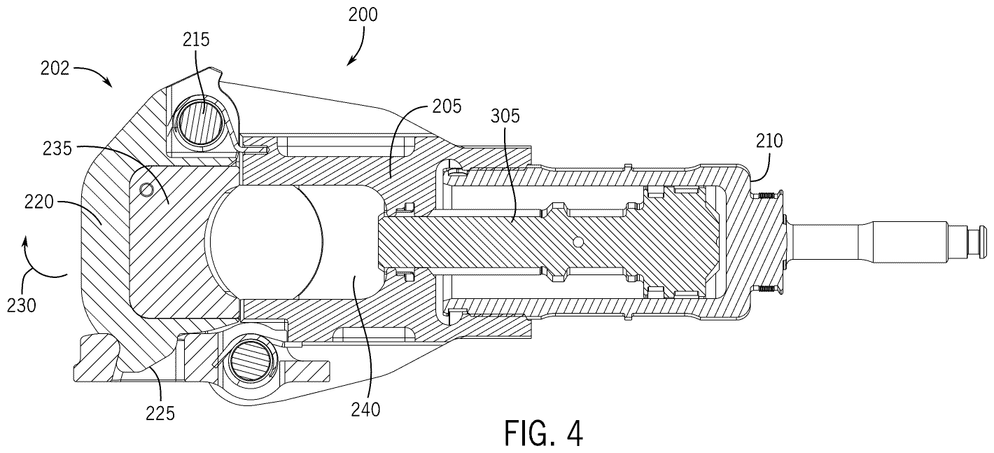

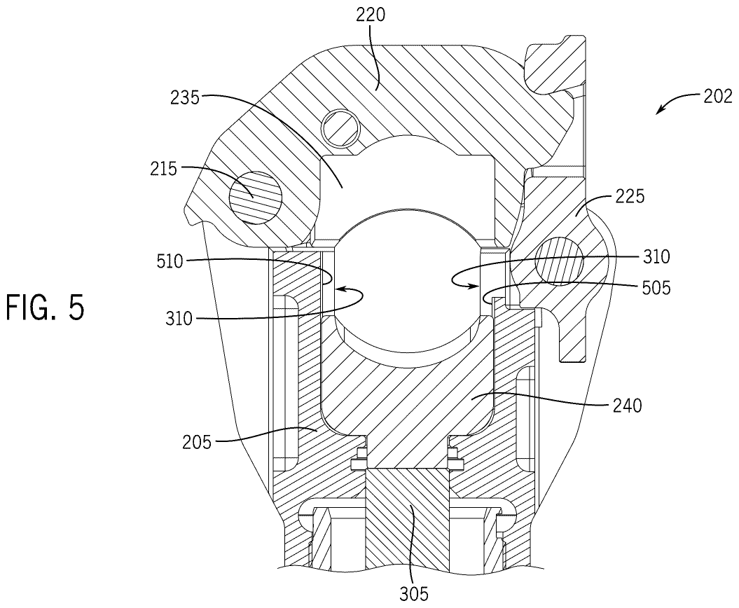

FIGS. 2-5 show an example of a crimper/cutter assembly 200 of the hydraulic tool 100. The crimper/cutter assembly 200 may include a head 202 and a body (e.g., a ram housing) 210. The head 202 may include a clevis 205 pivotally connected to a rotatable jaw 220. For example, the jaw 220 may be secured one side of the clevis 205 via a pivot pin 215 about which the jaw 220 may rotate as shown by arrow 230 (e.g., between an open configuration and a closed configuration). On an opposite size of the clevis 205, the jaw 220 may be selectively secured (e.g., in the closed configuration shown in FIG. 2) via a latch 225.

In some examples, in order to perform work on a workpiece (e.g., perform a crimp, cut, etc.), the head 202 may include one or more dies (e.g., crimping dies, cutting dies, etc.) For example, the head 202 may include a first die 235, which may be secured within the jaw 220 of the head. In some examples, the first die 235 may be a fixed die, which is stationary and does not move during a crimping or cutting process. In other examples, the first die may be a moveable die, which does move during the crimping or cutting process. Correspondingly, the head 202 may include a second die 240, which may be secured within the clevis 205 of the head. In some examples, the second die 240 may be a moveable die, which may be actuated (e.g., towards the first die 235) via movement of a ram 305. As should be appreciated, both the first and second dies 235, 240 may be replaceable, so that the tool 100 may operate as a crimping tool or a cutting tool depending on whether a crimping die, a cutting die, or otherwise is installed in the head 202.

In some examples, in order to guide movement of the second die 240 (e.g., the moveable die) the clevis 205 may define a guide channel 310. The guide channel 310 may guide movement of the second die 240 (e.g., in the direction shown by arrow 320) to prevent the die 240 from coming loose during a crimp/cut. For example, the guide channel 310 may be defined on a first side by a shelf 505 and on a second, opposite side by a wall 510. In some examples, a height of the shelf 505 may be shorter than a height of the wall 510. Further, in some examples, the shelf 505 and the wall 510 may serve as guides for the installation and removal of the second die 240.

In some examples, to retain the first die 235 within the jaw 220, the jaw 220 may define a guide channel 315. In some examples, during a crimp/cut, an opening 245 defined between the first and second dies 235, 240 may shrink as the second die 240 moves in the direction shown by arrow 320. Thus, a force may be applied to the workpiece via the first and second dies 235, 240.

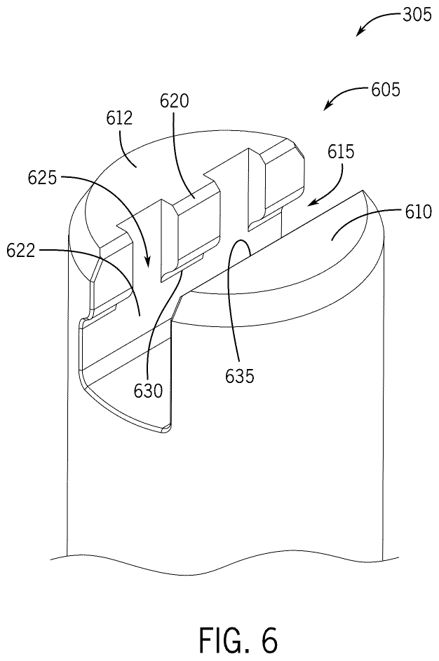

FIG. 6 shows an example of the ram 305, which may include a keyed first end 605. In some examples, the keyed first end 605 of the ram 305 may be configured to interact (e.g., mate) with a portion of the second die 240 to secure the second die 240 to the head 202. In some examples, the keyed first end 605 may include a first ledge 610 and a second ledge 612, which together may define a slot 615. The slot 615 may be configured to receive a portion of the second die 240 and retain the second die 240 via one or more protrusions 620 extending away from a surface 622 of the second ledge 612 (e.g., extending into the slot 615). In some examples, the protrusions 620 may each include a chamfered end 630, which may be configured to interlock with a portion of the second die 240 (e.g., to secure the second die 240 within the slot 615). In some examples, in order to facilitate removal and replacement of the second die 240, the protrusions 620 may be separated by and define a series of grooves 625.

In some examples, the first ledge 610, which may be oriented opposite the slot 615 from the second ledge 612, may not include the protrusions 620 or the grooves 625. Instead, the first ledge 610 may include a surface 635 that is substantially smooth, without any protrusions or grooves. However, in other examples, the surface 635 of the first ledge 610 may include one or more protrusions or one or more grooves, depending on the intended use case.

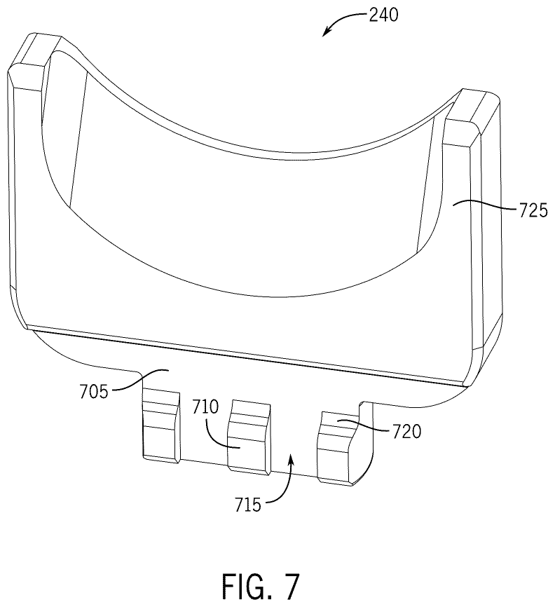

Turning to FIG. 7, an example of a second (e.g., moveable) die 240 of the tool 100 is shown. As mentioned previously, the second die 240 may be interchanged within the head 202 of the tool 100 based on the intended use of the tool 100 (e.g., crimping, cutting, etc.) Thus, to facilitate the interchangeability of the die 240, the die 240 may include a flange 705, which may extend from a body 725 of the second die 240. In some examples, the flange 705 may include one or more protrusions 710 separated by one or more grooves 715. In some examples, the one or more protrusions 710 may be configured to interlock with the one or more protrusions 620 of the ram 305 (e.g., to secure the second die 240 within the head 202). For example, a chamfered end 720 of the protrusions 710 may interlock with the chamfered end 630 of the protrusions 620.

Additionally, the one or more grooves 715 may be configured to permit removal and replacement of the second die 240. For example, the one or more grooves 715 may serve as a passage for the one or more protrusions 620 of the ram 305 (e.g., for the protrusions 620 to pass through the grooves 715 during removal/replacement of the second die 240).

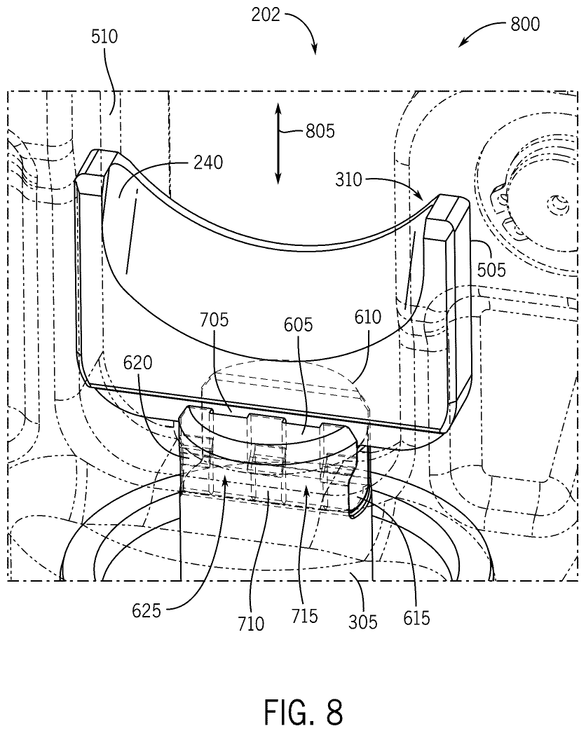

An example of a die retention mechanism 800 for securing the second die 240 to the ram 305 is shown in FIG. 8. As shown, when the second die 240 is secured to the ram 305, the protrusions 710 of the die 240 and the protrusions 620 of the ram 305 may be aligned. Additionally, the die 240 may be arranged within the guide channel 310, between the shelf 505 and the wall 510. Thus, as the ram 305 moves in the directions shown by arrow 805, the second die 240 moves within the guide channel 310. Further, the second die 240 is retained in contact with the ram 305 via the abutment between the protrusions 620, 710. In some examples, the shelf 505 and the wall 510 further constrain lateral movement of the die 240, which prevents the protrusions 710 of the die 240 from becoming misaligned (e.g., coming out of contact) with the protrusions 620 of the ram 305.

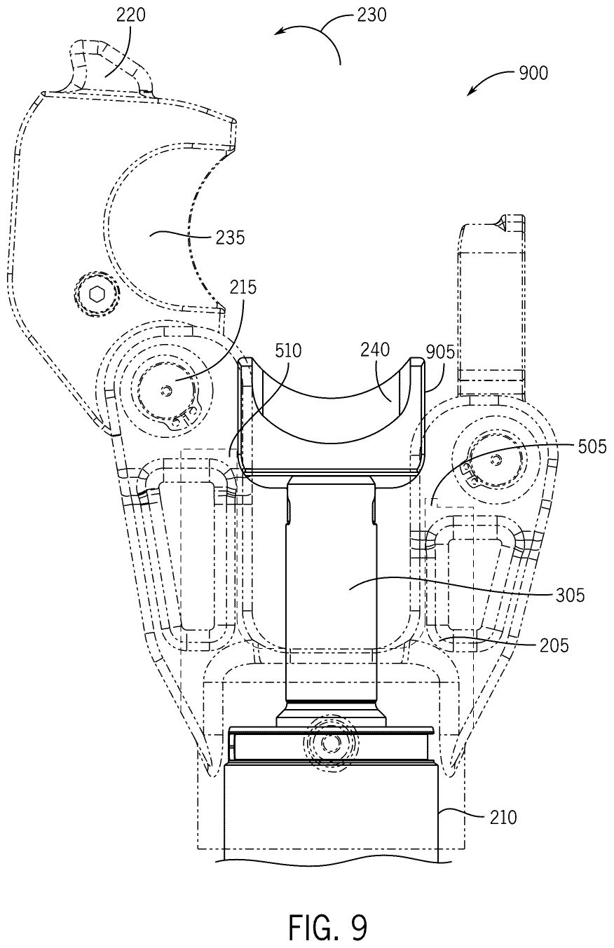

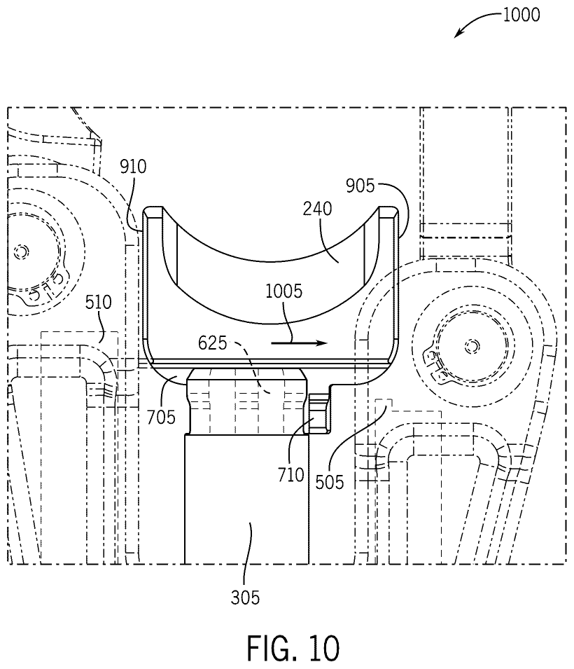

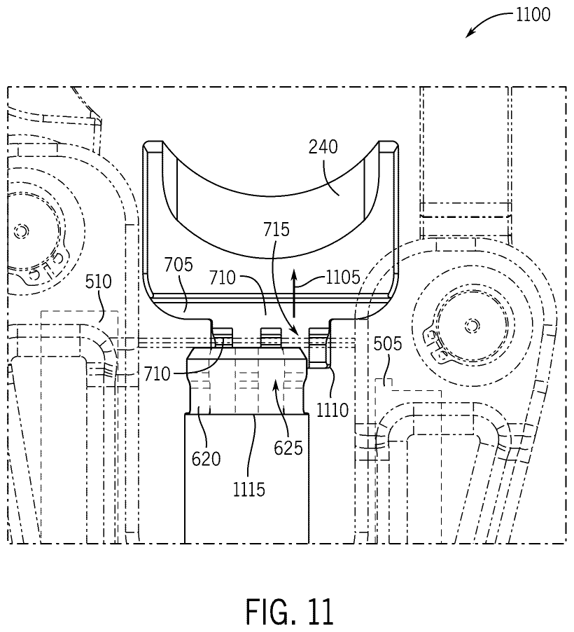

FIGS. 9-11 show an example of a removal process of the second die 240 from the head 202. For example, as shown at stage 900, in order to remove the second die 240, the ram 305 may first be actuated into a fully-extended position (e.g., as shown in FIG. 9). In the fully-extended position, a first side 905 of the second die 240 may be positioned past (e.g., beyond) the shelf 505. However, a second, opposite side 910 of the second die 240 may remain in contact with the wall 510.

Further, to permit an operator to access the second die 240, the operator may actuate the latch 225 so that the operator may grasp and rotate the jaw 220 about the pivot pin 215 into an open configuration (e.g., as shown in FIG. 9). Once in the open position, the operator may grip the second die 240 and apply a lateral force to the die 240 (e.g., in the direction shown by arrow 1005) at stage 1000 of the removal process. In some examples, as the ram 305 is in the fully-extended state, with the first side 905 of the second die 240 past the shelf 505, movement of the die 240 in the direction shown by arrow 1005 may misalign the protrusions 710 of the die 240 and the protrusions 620 of the ram 305. Thus, as shown at stage 1100, once the protrusions 620, 710 are misaligned, the operator may apply a force to the second die 240 in the direction shown by arrow 1105, which may move the protrusions 710 of the die 240 through the grooves 625 of the ram 305. Correspondingly the protrusions 620 of the ram 305 may pass through the grooves 715 of the die 240. Thus, as should be appreciated, the die 240 may be removed from the ram 305.

In some examples, in order to reinstall or replace the die 240, the stages listed above may be performed in opposite order. For example, with the ram 305 in the fully-extended position, the operator may slide the protrusions 710 of the die 240 through the grooves 625 of the ram 305, until a base 1110 of the flange 705 contacts a base 1115 (e.g., of the slot) of the ram 305. Following this, the operator may apply a lateral force to the die 240, which may seat the die 240 within the guide channel 310, with the second side 910 of the die 240 contacting the wall 510 of the guide channel 310. In some examples, when the second side 910 of the die 240 contacts the wall 510, the protrusions 710 of the die 240 may be aligned with the protrusions 620 of the ram 305 (e.g., the protrusions may lock together via the chamfered ends). In some examples, the operator may then retract the ram 305, which may trap the die 240 within the guide channel 310, with the first side 905 of the die 240 contacting the shelf 505 and the second side 910 of the die 240 contacting the wall 510.

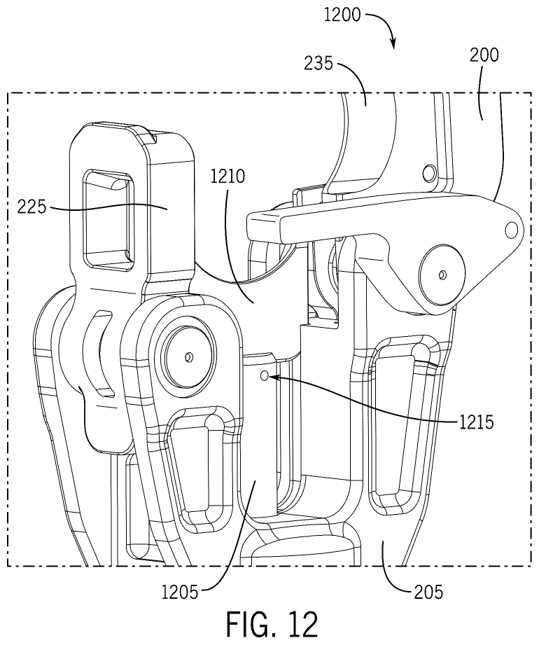

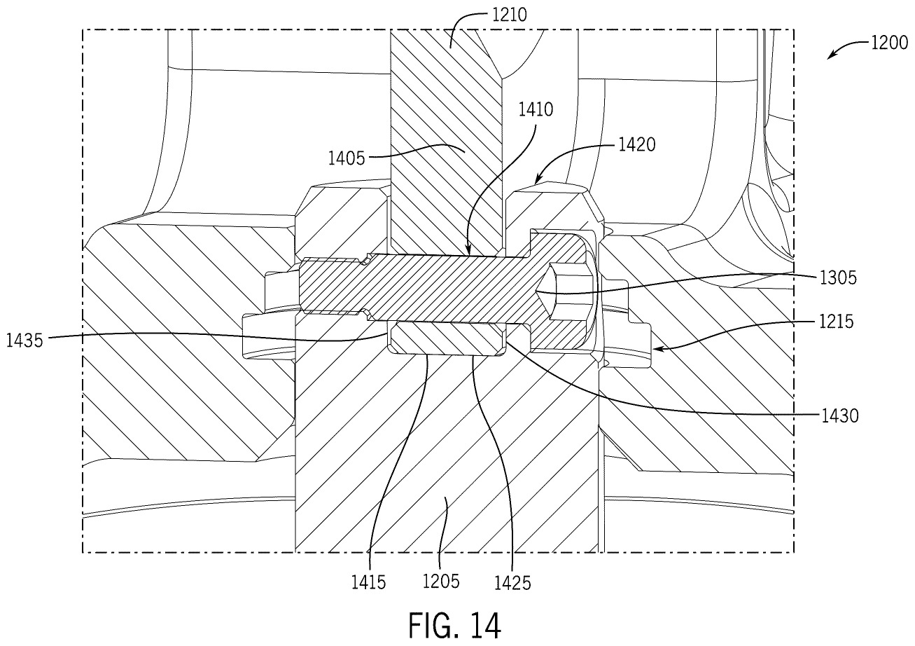

FIGS. 12-14 illustrate another example of a die retention mechanism 1200 that can be used with the hydraulic tool 100 of FIG. 1 (e.g., as an alternative configuration of the die retention mechanism 800). As will be recognized, the die retention mechanism 1200 shares a number of components in common with and operates in a similar fashion to the examples illustrated and described previously. For the sake of brevity, these common features will not be again described below in detail. Rather, previous discussion of commonly named or numbered features, unless otherwise indicated, also applies to example configurations of the die retention mechanism 1200.

In some examples, the die retention mechanism 1200 may include a ram 1205 defining a cutout 1420. The cutout 1420 may be configured to receive a mounting flange 1405 of a die 1210 (e.g., a crimping or cutting die). For example, the mounting flange 1405 may be arranged within the cutout 1420 until a base 1415 of the flange 1405 contacts a base 1425 of the cutout 1420. In some examples, one or more sidewalls 1430 of the cutout 1420 may contact sides 1435 of the mounting flange 1405 in order to provide support to the die 1210. In some examples, to further secure the die 1210 to the ram 1205 (e.g., for movement therewith), the ram 1205 may define an aperture 1215 configured to receive and secure a fastener 1305 (e.g., a screw, bolt, nail, or any other known removable fastener). Correspondingly, the mounting flange 1405 may define an opening 1410 configured to receive the fastener 1305 therethrough. Thus, in some examples, when the mounting flange 1405 is received within the cutout 1420, the opening 1410 of the mounting flange 1405 and the aperture 1315 of the ram 1205 may be aligned so that the fastener 1305 may pass through the aperture 1215 and the opening 1410 to secure the die 1210 to the ram 1205. In some examples, the aperture 1215 may be a threaded aperture configured to receive a threaded fastener, while the opening 1410 may not include any threads.

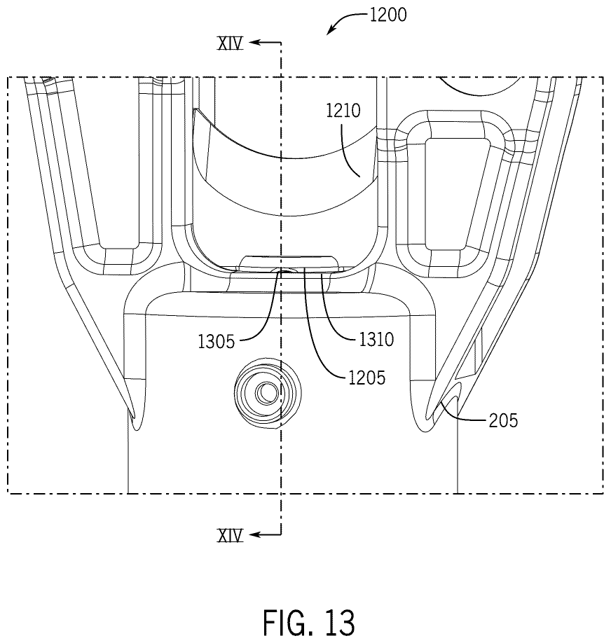

In one example use case, to install the die 1210 on the ram 1205, an operator may first drive the ram 1205 into a fully-extended position. Following this, the operator may align the mounting flange 1405 within the cutout 1420 so that the opening 1410 aligns with the aperture 1215 of the ram 1205. Following this, the operator may arrange the fastener 1305 through the ram 1205 and the die 1210 to secure the die to the ram. In some examples, the fastener 1305 may be recessed within the aperture 1215 so that, in a fully-retracted position (e.g., as shown in FIG. 13) the fastener 1305 may be arranged below a lip 1310 of the clevis 205. Thus, full extension or retraction of the ram 1205 may be unaffected by the fastener 1305.

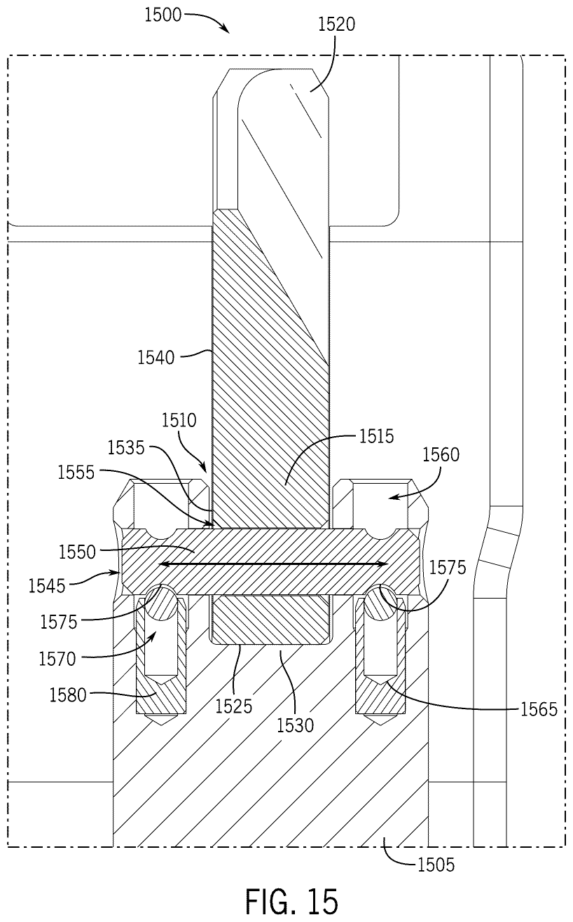

FIG. 15 illustrates another example of a die retention mechanism 1500 that can be used with the hydraulic tool 100 of FIG. 1 (e.g., as an alternative configuration of the die retention mechanism 1200). As will be recognized, the die retention mechanism 1500 shares a number of components in common with and operates in a similar fashion to the examples illustrated and described previously. For the sake of brevity, these common features will not be again described below in detail. Rather, previous discussion of commonly named or number features, unless otherwise indicated, also applies to example configurations of the die retention mechanism 1500.

In some examples, the die retention mechanism 1500 may include a ram 1505 defining a cutout 1510. The cutout 1510 may be configured to receive a mounting flange 1515 of a die 1520 (e.g., a crimping or cutting die). For example, the mounting flange 1515 may be arranged within the cutout 1510 until a base 1525 of the mounting flange 1515 contacts a base 1530 of the cutout 1510. In some examples, one or more sidewalls 1535 of the cutout 1510 may contact sides 1540 of the mounting flange 1515 in order to provide support to the die 1520. In some examples, to further secure the die 1520 to the ram 1505, the ram 1505 may define an aperture 1545 configured to receive a pin 1550. Correspondingly, the mounting flange 1515 may define an opening 1555, which may be axially aligned with the aperture 1545 to receive the pin 1550 therethrough.

In some examples, the pin 1550 may include one or more grooves 1575 (e.g., circumferential grooves) arranged at opposing ends of the pin. Thus, when the pin 1550 is installed though the aperture 1545 and the opening 1555, a detent (e.g., a first detent) 1565 may engage the one of the grooves 1575 to secure the pin in position. As a result, the die 1520 may be secured within the ram 1505.

In some examples, the ram 1505 may include one or more pockets configured to receive and hold the detent(s). For example, the ram 1505 may include a first pocket 1560 configured to receive the first detent 1565 and a second pocket 1570 to receive a second detent 1580. In some examples, the first and second pockets 1560, 1570 may be arranged on opposing sides of the cutout 1510. Thus, the first detent 1565 may be configured to engage with a first groove of the pin 1550 and the second detent 1580 may be configured to engage with a second groove of the pin 1550, when the pin is installed within the aperture 1545. Put differently, in some examples, when the mounting flange 1515 is received within the cutout 1510, the opening 1555 of the mounting flange 1515 and the aperture 1545 of the ram 1505 may be aligned so that the pin 1550 may pass through the aperture 1545 and the opening 1555. Correspondingly, the first detent 1565 may engage the first groove of the pin and the second detent 1580 may engage the second groove of the pin, which secure the die 1520 to the ram 1505.

In one example use case, to install the die 1520 on the ram 1505, an operator may drive the ram 1505 into a fully-extended position (e.g., to expose the aperture 1545). Following this, the operator may align the mounting flange 1515 within the cutout 1510 so that the opening 1555 aligns with the aperture 1545 of the ram 1505. Following this, the operator may push the pin 1550 through the aperture 1545 and the opening 1555 so that the first detent 1565 engages the first groove and the second detent 1580 engages the second groove. Thus, the pin 1550 may secure the die 1520 to the ram 1505. Further, the first and second detents 1565, 1580 may prevent unwanted axial movement of the pin 1550 (e.g., to mitigate the risk of the pin coming out of the aperture). Further, the pin 1550 may be recessed within the aperture 1545 so that full extension or retraction of the ram 1505 is unaffected by the pin 1550.

In another example use case, to remove the die 1520 on the ram 1505, an operator may drive the ram 1505 into the fully-extended position (e.g., to expose the aperture 1545). Following this, the operator may use a tool (e.g., a hex key or any other known tool) to apply a force to an end of the pin 1550. As a result of the force applied by the operator, the detent may be compressed (e.g., a biasing element within the detent may compress), which may disengage the detent from the groove of the pin and permit the operator to push the pin 1550 through the aperture 1545. Thus, once the operator has removed the pin 1550 from engagement with the opening 1555 of the die, the operator may remove the die 1520 from the ram 1505.

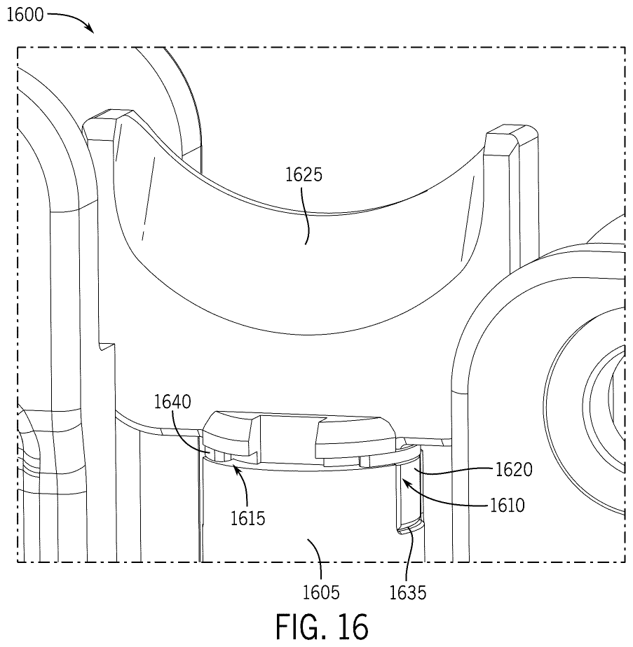

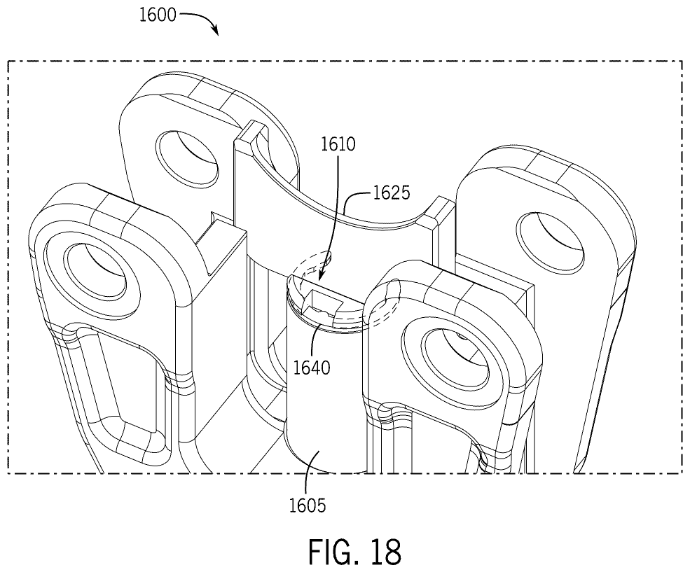

FIGS. 16-18 illustrate another example of a die retention mechanism 1600 that can be used with the hydraulic tool 100 of FIG. 1 (e.g., as an alternative configuration of the die retention mechanism 1200). As will be recognized, the die retention mechanism 1600 shares a number of components in common with and operates in a similar fashion to the examples illustrated and described previously. For the sake of brevity, these common features will not be again described below in detail. Rather, previous discussion of commonly named or number features, unless otherwise indicated, also applies to example configurations of the die retention mechanism 1600.

In some examples, the die retention mechanism 1600 may include a ram 1605 defining a cutout 1610. The cutout 1610 may be configured to receive a mounting flange 1620 of a die 1625. In some examples, the ram 1605 may include a radial groove 1615 and the mounting flange 1620 may include a radial groove 1630. In some examples, when the mounting flange 1620 of the die 1625 is inserted within the cutout 1610 of the ram 1605 (e.g., so a base 1635 of the mounting flange contacts a bottom of the cutout), the radial grooves 1615, 1630 may be aligned. In some examples, to secure the die 1625 to the ram 1605, a retaining clip (e.g., a snap ring, C-clip, etc.) 1640 may be arranged within the radial grooves 1615, 1630. Thus, when the mounting flange 1620 is received within the cutout 1610, the radial groove 1615 of the ram 1605 and the radial groove 1630 of the mounting flange 1620 may be aligned so that the retaining clip 1640 is received in both radial grooves 1615, 1630 to secure the die 1625 to the ram 1605.

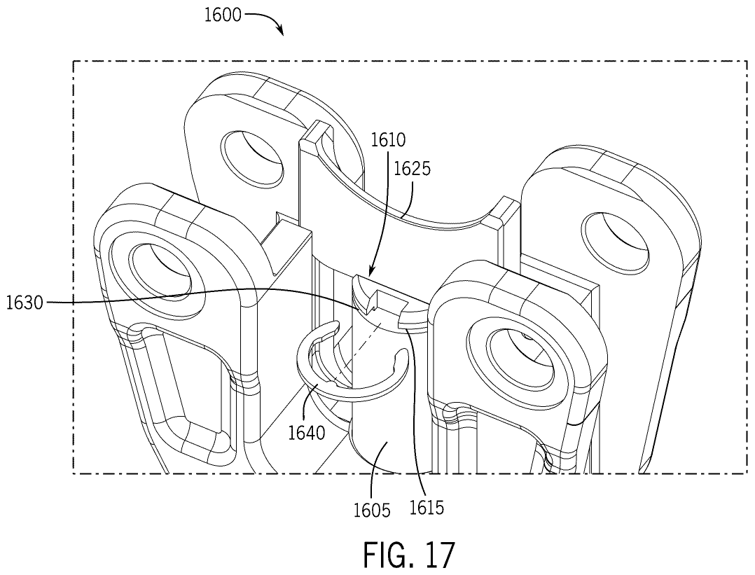

In one example use case, to install the die 1625 on the ram 1605, an operator may first drive the ram 1605 into an extended position (e.g., to provide access to the radial grooves. Following this, the operator may align the mounting flange 1620 within the cutout 1610. Following this, the operator may install the retaining clip 1640 within the radial grooves 1615, 1630 to secure the die 1625 to the ram 1605 (e.g., snap the retaining clip in place by applying a force in the direction shown by arrow in FIG. 17). In some examples, the radial grooves have a depth sufficient to permit the retaining clip 1640 to be recessed within the grooves so that full extension or retraction of the ram 1605 is unaffected by the retaining clip 1640.

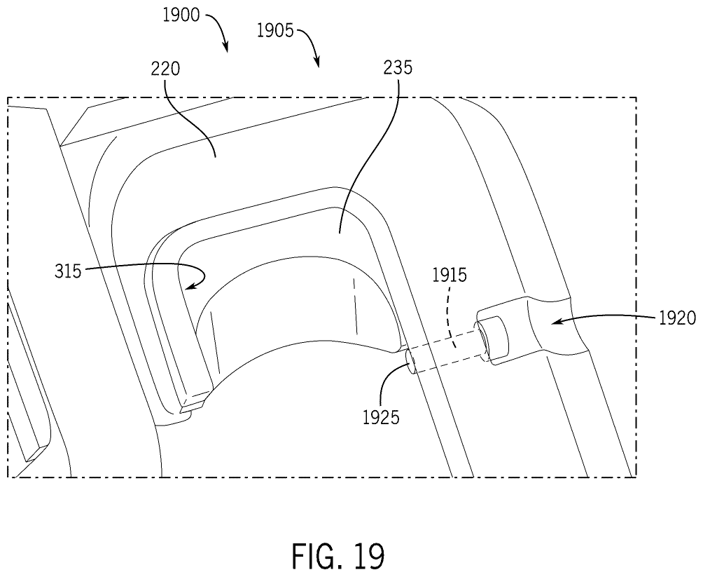

FIG. 19 shows an example of a head 1900 of the hydraulic tool 100, which may include a die retention mechanism 1905. In some examples, the die retention mechanism 1905 may be configured to retain the first (e.g., fixed) die 235 within the jaw 220 of the head 1900. For example, in order to retain the first die 235, the operator may insert the first die 235 with the guide channel 315, until a base of the first die 235 contacts an end wall of the guide channel 315. Following this, the operator may install a fastener 1915 through an opening 1920 defined by the jaw 220 (e.g., in an end wall of the jaw). In some examples, the fastener 1915 may be recessed within the jaw 220 (e.g., within the opening 1920).

As should be appreciated, the location of the opening 1920 (and thus the fastener 1915) may be positioned with an end 1925 of the fastener 1915 protruding into the guide channel 315. Thus, the fastener 1915 may prevent the removal of the first die 235 from the guide channel 315 (and thus the jaw 220) by blocking a removal path of the first die 235. In some examples, to remove or replace the first die 235, the operator may first remove the fastener 1915, which permits the operator to slide the first die 235 out of the guide channel 315.

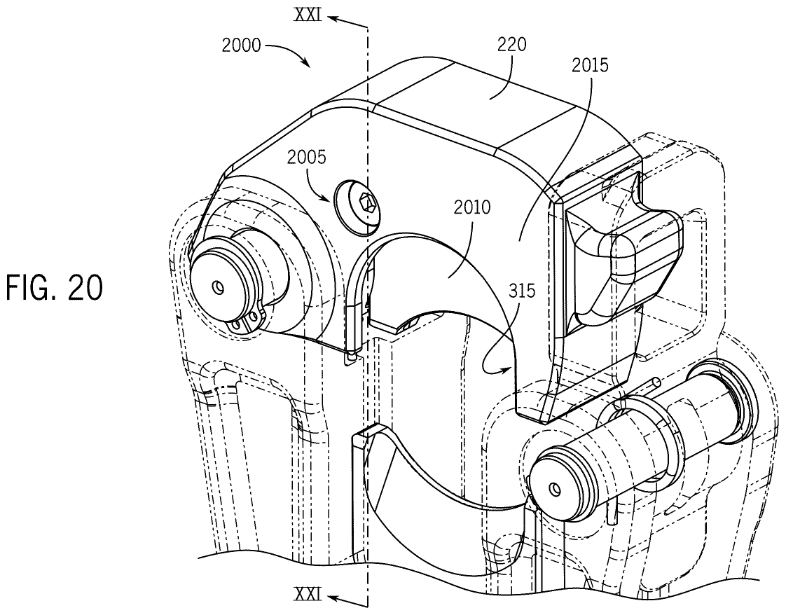

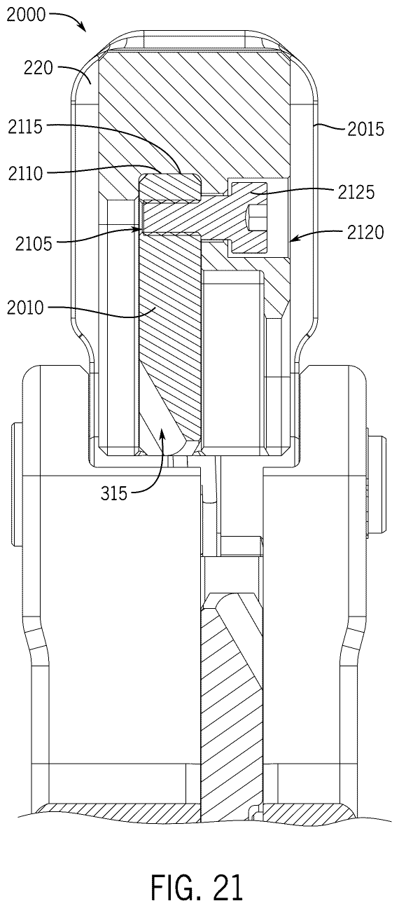

FIGS. 20 and 21 illustrate another example of a head 2000 of the hydraulic tool 100, which may include a die retention mechanism 2005 (e.g., as an alternative configuration of the die retention mechanism 1905). As will be recognized, the die retention mechanism 2005 shares a number of components in common with and operates in a similar fashion to the examples illustrated and described previously. For the sake of brevity, these common features will not be again described below in detail. Rather, previous discussion of commonly named or number features, unless otherwise indicated, also applies to example configurations of the die retention mechanism 2005.

In some examples, the die retention mechanism 2005 may be configured to retain a die (e.g., a fixed die) 2010 within the jaw 220 of the head 2000. For example, the die 2010 may be arranged within the guide channel 315, until a base 2110 of the die 2010 contacts an end wall 2115 of the guide channel 315. In some examples, once the base 2110 contacts the end wall 2115, an opening 2105 within the die 2010 may be aligned with a corresponding aperture 2120 in a face 2015 of the jaw 220. Thus, a fastener 2125 may be arranged through the aperture 2120 and extend into the opening 2105 to secure the die 2010 within the guide channel 315. In some examples, arranging the aperture 2120 within the face 2015 of the jaw 220 may mitigate the risk of the operator installing the die 2010 incorrectly.

In an example use case, to install the die 2010 within the jaw 220, an operator may open (e.g., rotate) the jaw 220 and insert the die 2010 within the guide channel 315 until the base 2110 of the die 2010 contacts the end wall 2115 of the guide channel 315. Following this, the operator may install the fastener 2125 within the aperture 2120 so a first end of the fastener passed into the opening 2105, which secures the die 2010 within the guide channel 315.

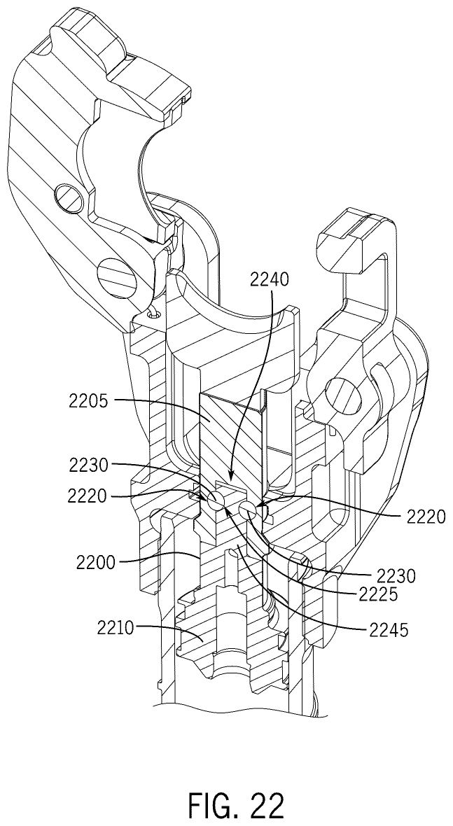

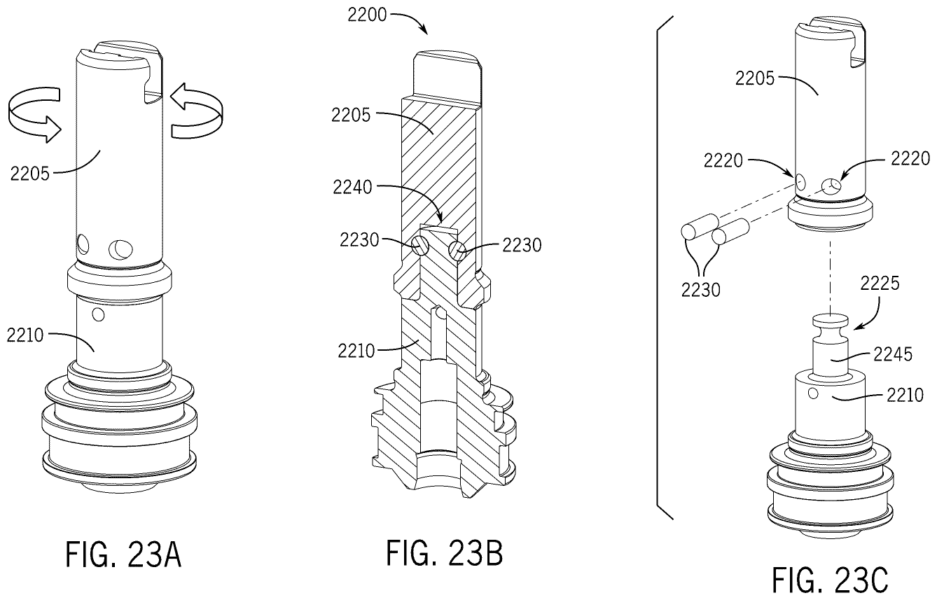

FIGS. 22 and 23A-C illustrate an example configuration of a ram 2200 of the hydraulic tool 100. In some examples, the ram 2200 may be in the form of a multi-piece ram assembly, which may include a first portion 2205 and a second portion 2210. In some examples, the first portion 2205 of the ram 2200 may be rotatably secured to the second portion 2210. Thus, the first portion 2205 of the ram 2200 may rotate along an axis formed by the ram (e.g., with 360 degrees of rotation).

In some examples, in order to secure the first portion 2205 to the second portion 2210, the first portion 2205 may be partially hollow, (e.g., define a pocket 2240 at a first end). The pocket 2240 may be configured to receive a corresponding protrusion 2245 extending from a first end of the second portion 2210. Further, the first portion 2205 may include one or more apertures 2220 extending into the pocket 2240. In some examples, when the protrusion 2245 of the second portion 2210 is positioned within the pocket, a groove 2225 of the second portion 2210 may be aligned with the aperture 2220. Thus, to rotatably secure the first portion to the second portion, one or more pins 2230 may be arranged through the apertures 2220 and corresponding groove 2225.

As should be appreciated, the pins 2230 may create a radial path around the groove 2225 to permit the first portion 2205 and the second portion 2210 to rotate independently of each other (e.g., about an axis formed by the ram), while being axially constrained. Thus, an operator may position a die (e.g., connected to the first portion of the ram) in multiple positions (e.g., to facilitate insertion/removal of the die).

In one particular example, the first portion 2205 may include two apertures 2220, which may be configured to receive two pins 2230. However, in other examples, other numbers of apertures or pins may be utilized.

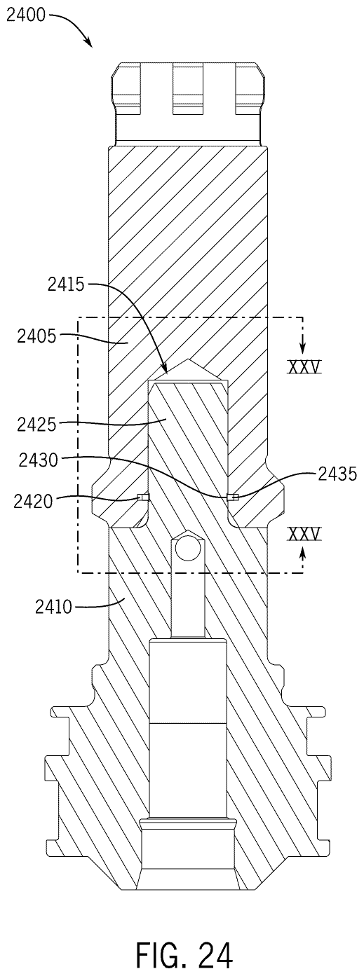

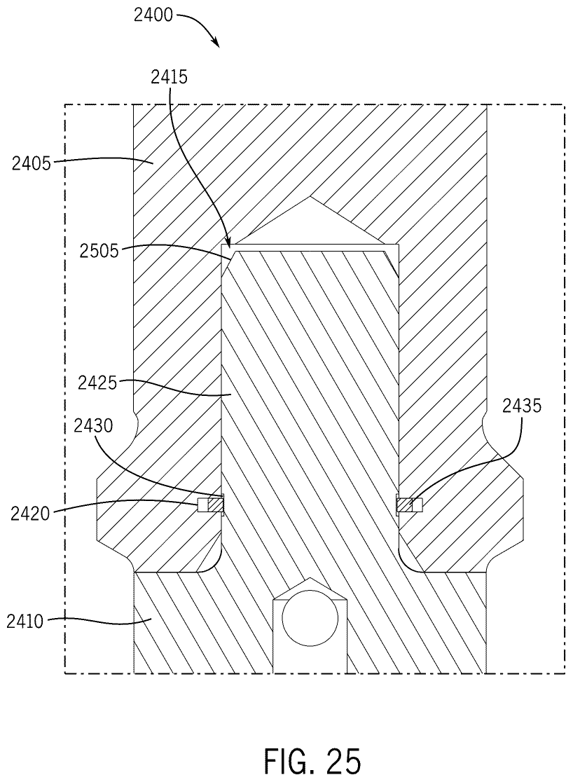

FIGS. 24 and 25 illustrate another example of a ram 2400 of the hydraulic tool 100 (e.g., as an alternative configuration of the ram 2200). As will be recognized, the ram 2400 shares a number of components in common with and operates in a similar fashion to the examples illustrated and described previously. For the sake of brevity, these common features will not be again described below in detail. Rather, previous discussion of commonly named or number features, unless otherwise indicated, also applies to example configurations of the ram 2400.

In some examples, the ram 2400 may be in the form of a multi-piece ram assembly, which may include a first portion 2405 and a second portion 2410. In some examples, the first portion 2405 of the ram 2400 may be rotatably secured to the second portion 2410. Thus, the first portion 2405 of the ram 2400 may rotate along an axis formed by the ram (e.g., 360 degrees of rotation). To facilitate this, the ram 2400 include a pocket 2415 configured to receive a protrusion 2425 extending from second portion 2410. In some examples, the first portion 2405 may include a circumferential groove 2420, which when the protrusion is arranged within the pocket, may align with a corresponding circumferential groove 2430 of the second portion 2410. Further, a retention clip 2435 may be positioned within the grooves 2420, 2430 to rotationally secure the first portion 2405 to the second portion 2410, while restricting axial movement of the first portion relative to the second portion.

In one example use case, to secure the first portion 2405 to the second portion 2410, an operator may position the retaining clip 2435 within the groove 2420 of the first portion 2405. Following this, the operator may align the protrusion 2425 with the pocket 2415 and begin to push the protrusion 2425 within the pocket 2415. As the protrusion moves within the pocket, a chamfered end 2505 of the protrusion may contact the retaining clip 2435. As the protrusion is continued to be pushed within the pocket, the chamfered end 2505 may apply an outward force to the retaining clip, which may expand the retaining clip into the groove 2420. Thus, the clip may slide along an outer surface of the protrusion until reaching the groove 2430. Once the clip reaches the groove 2430, the clip (e.g., a biased clip) may snap into the groove 2430 so that the clip is secure between the grooves 2420, 2430. Thus, the first portion 2405 and the second portion 2410 may be secured together (e.g., to form the ram 2400). As should be appreciated, the retaining clip 2435 permits the first portion 2405 and the second portion 2410 to rotate independently, while restricting axial movement of the first portion relative to the second portion.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

### FURTHER EXAMPLES

Example 1. A die retention mechanism for a hydraulic power tool, the die retention mechanism comprising: a first die including a flange and a first series of keyed protrusions extending from the flange; and a ram, including: a first end defining a slot, the slot to receive the flange of the first die; a first ledge and a second ledge together defining the slot, the first ledge including a second series of keyed protrusions; and the second series of keyed protrusions interlocking with the first series of keyed protrusions to secure the first die to the ram.

Example 2. The die retention mechanism of Example 1, wherein the first die and the ram are retained within a head of the hydraulic power tool.

Example 3. The die retention mechanism of any one of Examples 1 to 2, wherein the head of the hydraulic power tool includes: a clevis defining a guide channel to guide movement of the first die during movement of the ram.

Example 4. The die retention mechanism of Example 3, wherein the guide channel includes: a first side defining a wall; and a second side defining a shelf, the wall and the shelf contacting opposing sides of the first die during movement of the first die.

Example 5. The die retention mechanism of Example 4, wherein a height of the shelf is less than a height of the wall.

Example 6. The die retention mechanism of any one of Examples 4 to 5, wherein, when the first die is secured to the ram, the shelf and the wall of the clevis mitigate lateral movement of the first die.

Example 7. The die retention mechanism of any one of Examples 1 to 6, wherein the first die is one of a crimping die or a cutting die.

Example 8. The die retention mechanism of any one of Examples 1 to 7, wherein the ram further includes: a first portion defining a pocket at one end; and a second portion defining a protrusion at one end, the protrusion of the second portion nesting within the pocket of the first portion to rotatably secure the first portion to the second portion.

Example 9. The die retention mechanism of Example 8, wherein the first portion is rotatably secured to the second portion via a pin arranged through an aperture in the first portion and into a groove of the second portion.

Example 10. The die retention mechanism of Example 8, wherein the first portion is rotatably secured to the second portion via a retaining clip arranged between a first groove of the first portion and a second groove of the second portion.

Example 11. A method of securing a die to a ram of a hydraulic power tool, the method comprising: extending the ram of the hydraulic power tool into an extended position, the ram arranged within a head of the hydraulic power tool, and the ram having a first end defining a slot with a first series of protrusions separated by a first series of grooves; aligning a mounting flange of the die with the slot in the ram, the mounting flange having a second series of protrusions separated by a second series of grooves; sliding the second series of protrusions of the die through the first series of grooves of the ram in a first direction; and sliding the second series of protrusions of the die in a second direction, perpendicular to the first direction, until the second series of protrusions of the die align with the first series of protrusions of the ram.

Example 12. The method of Example 11, further comprising: sliding the second series of protrusions of the die in the second direction until a first side of the die contacts a wall formed in the head of the hydraulic power tool.

Example 13. The method of any one of Examples 11 to 12, further comprising: sliding the second series of protrusions of the die in the first direction until the mounting flange contacts a base of the slot in the ram.

Example 14. The method of any one of Examples 11 to 13, wherein the ram further includes: a first portion defining a pocket at one end; and a second portion defining a protrusion at one end, the protrusion of the second portion nesting within the pocket of the first portion to rotatably secure the first portion to the second portion.

Example 15. The method of Example 14, wherein the first portion is rotatably secured to the second portion via a pin arranged through an aperture in the first portion and into a groove of the second portion.

Example 16. The method of Example 14, wherein the first portion is rotatably secured to the second portion via a retaining clip arranged between a first groove of the first portion and a second groove of the second portion.

Example 17. A hydraulic tool, comprising: a body; and a head extending from the body, the head including: a ram moveable between a retracted position and an extended position; and a die retention mechanism removably securing a die to the ram, the die retention mechanism including: a slot in a first end of the ram, the slot having a first series of keyed protrusions; and a flange extending from the die, the flange having a second series of keyed protrusions to interlock with the first series of keyed protrusions of the slot to secure the die to the ram.

Example 18. The hydraulic tool of Example 17, wherein the first series of keyed protrusions of the slot and the second series of keyed protrusions of the flange include interlocking chamfered edges.

Example 19. The hydraulic tool of any one of Examples 17 to 18, wherein the first series of keyed protrusions and the second series of keyed protrusions are interspaced by grooves.

Example 20. The hydraulic tool of Example 19, wherein grooves of the first series of keyed protrusions receive the second series of keyed protrusions during installation of the die.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

As used herein, unless otherwise defined or limited, directional terms are used for convenience of reference for discussion of particular figures or examples. For example, references to downward (or other) directions or top (or other) positions may be used to discuss aspects of a particular example or figure, but do not necessarily require similar orientation or geometry in all installations or configurations.

Also as used herein, unless otherwise limited or defined, “substantially parallel” indicates a direction that is within ±12 degrees of a reference direction (e.g., within ±6 degrees), inclusive.

Also as used herein, unless otherwise limited or defined, “substantially perpendicular” indicates a direction that is within ±12 degrees of perpendicular a reference direction (e.g., within ±6 degrees), inclusive.

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of +15% or less, inclusive of the endpoints of the range. Similarly, the term “substantially equal” (and the like) as used herein with respect to a reference value refers to variations from the reference value of less than +10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. A die retention mechanism for a hydraulic power tool, the die retention mechanism comprising:
a first die including a flange and a first series of keyed protrusions extending from the flange; and
a ram, including:
a first end defining a slot, the slot to receive the flange of the first die;
a first ledge and a second ledge together defining the slot, the first ledge including a second series of keyed protrusions; and
the second series of keyed protrusions interlocking with the first series of keyed protrusions to secure the first die to the ram.

2. The die retention mechanism of claim 1, wherein the first die and the ram are retained within a head of the hydraulic power tool.

3. The die retention mechanism of claim 2, wherein the head of the hydraulic power tool includes:
a clevis defining a guide channel to guide movement of the first die during movement of the ram.

4. The die retention mechanism of claim 3, wherein the guide channel includes:
a first side defining a wall; and
a second side defining a shelf, the wall and the shelf contacting opposing sides of the first die during movement of the first die.

5. The die retention mechanism of claim 4, wherein a height of the shelf is less than a height of the wall.

6. The die retention mechanism of claim 4, wherein, when the first die is secured to the ram, the shelf and the wall of the clevis mitigate lateral movement of the first die.

7. The die retention mechanism of claim 1, wherein the first die is one of a crimping die or a cutting die.

8. The die retention mechanism of claim 1, wherein the ram further includes:
a first portion defining a pocket at one end; and
a second portion defining a protrusion at one end, the protrusion of the second portion nesting within the pocket of the first portion to rotatably secure the first portion to the second portion.

9. The die retention mechanism of claim 8, wherein the first portion is rotatably secured to the second portion via a pin arranged through an aperture in the first portion and into a groove of the second portion.

10. The die retention mechanism of claim 8, wherein the first portion is rotatably secured to the second portion via a retaining clip arranged between a first groove of the first portion and a second groove of the second portion.

11. A method of securing a die to a ram of a hydraulic power tool, the method comprising:
extending the ram of the hydraulic power tool into an extended position, the ram arranged within a head of the hydraulic power tool, and the ram having a first end defining a slot with a first series of protrusions separated by a first series of grooves;
aligning a mounting flange of the die with the slot in the ram, the mounting flange having a second series of protrusions separated by a second series of grooves;
sliding the second series of protrusions of the die through the first series of grooves of the ram in a first direction; and
sliding the second series of protrusions of the die in a second direction, perpendicular to the first direction, until the second series of protrusions of the die align with the first series of protrusions of the ram.

12. The method of claim 11, further comprising:
sliding the second series of protrusions of the die in the second direction until a first side of the die contacts a wall formed in the head of the hydraulic power tool.

13. The method of claim 11, further comprising:
sliding the second series of protrusions of the die in the first direction until the mounting flange contacts a base of the slot in the ram.

14. The method of claim 11, wherein the ram further includes:
a first portion defining a pocket at one end; and
a second portion defining a protrusion at one end, the protrusion of the second portion nesting within the pocket of the first portion to rotatably secure the first portion to the second portion.

15. The method of claim 14, wherein the first portion is rotatably secured to the second portion via a pin arranged through an aperture in the first portion and into a groove of the second portion.

16. The method of claim 14, wherein the first portion is rotatably secured to the second portion via a retaining clip arranged between a first groove of the first portion and a second groove of the second portion.

17. A hydraulic tool, comprising:
a body; and
a head extending from the body, the head including:
a ram moveable between a retracted position and an extended position; and
a die retention mechanism removably securing a die to the ram, the die retention mechanism including:
a slot in a first end of the ram, the slot having a first series of keyed protrusions; and
a flange extending from the die, the flange having a second series of keyed protrusions to interlock with the first series of keyed protrusions of the slot to secure the die to the ram.

18. The hydraulic tool of claim 17, wherein the first series of keyed protrusions of the slot and the second series of keyed protrusions of the flange include interlocking chamfered edges.

19. The hydraulic tool of claim 17, wherein the first series of keyed protrusions and the second series of keyed protrusions are interspaced by grooves.

20. The hydraulic tool of claim 19, wherein grooves of the first series of keyed protrusions receive the second series of keyed protrusions during installation of the die.
